(19) United States
(12) Patent Application Publication
(10) Pub. No.: US 2026/0058927 A1
(43) Pub. Date: Feb. 26, 2026

(54) SCORING SYSTEM FOR A SOCIAL MEDIA PLATFORM

(71) Applicant: Steve Everist, Denver, CO (US)

(72) Inventor: Steve Everist, Denver, CO (US)

(21) Appl. No.: 18/811,254

(22) Filed: Aug. 21, 2024

(51) Int. Cl. H04L 51/52; G06F 16/954; G06Q 50/00

(52) U.S. Cl. CPC H04L 51/52; G06F 16/954; G06Q 50/01

(57) ABSTRACT

A method for scoring messages on a social media platform, analyzing the scores and controlling navigation of the social media platform. The method includes using a computing device to provide a scoring triangle to a client device of a user of a social media platform associated with an initial message posted to the social media platform. A computing device for scoring messages on a social media platform, analyzing the scores and controlling navigation of the social media platform. The computing device includes at least one processor and at least one computer-readable medium storing instructions that are executable by the at least one processor to: display a scoring triangle on a client device of a user of a social media platform associated with an initial message posted to the social media platform.

### STATEMENT REGARDING FEDERALLY SPONSORED RESEARCH OR DEVELOPMENT

Not applicable.

### CROSS-REFERENCE TO RELATED APPLICATIONS

Not applicable.

### BACKGROUND OF THE DISCLOSURE

### 1. Field of the Invention

The present disclosure relates to a unique scoring system and information navigating system that can be used for comments or messages posted in a social media platform.

### 2. Description of the Related Art

Computing devices, such as smartphones, laptops, and desktop computers, have enabled users to create, spread, and consume user-generated content across a broad range of topics and geographic areas. Information distribution platforms allow users to identify specific topics of interest and share information related to the topics in a real-or near real-time manner. An information distribution platform may allow users to provide generic feedback or comment on the user-generated content.

### SUMMARY OF THE DISCLOSURE

The present disclosure is directed to a method for scoring messages on a social media platform, analyzing the scores and controlling navigation of the social media platform. The method includes using a computing device to provide a scoring triangle to a client device of a user of a social media platform associated with an initial message posted to the social media platform.

The present disclosure is also directed to a computing device for scoring messages on a social media platform, analyzing the scores and controlling navigation of the social media platform. The computing device includes at least one processor and at least one computer-readable medium storing instructions that are executable by the at least one processor to: display a scoring triangle on a client device of a user of a social media platform associated with an initial message posted to the social media platform.

### BRIEF DESCRIPTION OF THE DRAWINGS

FIGS. 1A-1C are screenshots of a social media platform that incorporates a message scoring and navigation system constructed in accordance with the present disclosure.

FIG. 2 is a close-up view of a scoring mechanism used by the message scoring and navigation system.

FIG. 3 is conceptual diagram illustrating an example system that is configured to score initial messages posted to the social media platform and control navigational features for the user, in accordance with one or more aspects of the present disclosure.

FIG. 4 is a flow diagram illustrating example operations of the message scoring and navigation system and a client device, in accordance with one or more aspects of the present disclosure.

FIG. 5 is a block diagram illustrating further details of an example message scoring and navigation system, in accordance with one or more aspects of the present disclosure.

### DETAILED DESCRIPTION OF THE DISCLOSURE

Techniques of the disclosure are directed to a process of providing a multifaceted scoring system and comparing and analyzing scoring results for online social comments or messages posted on a social media platform. The disclosure is also directed to a message/comment navigating system tied to the scoring system to manage interactions of users for the social media platform.

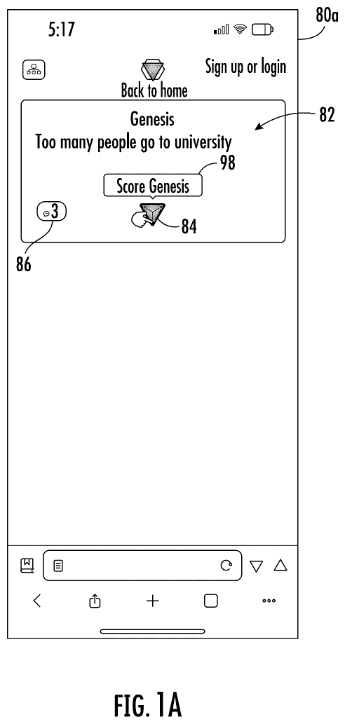

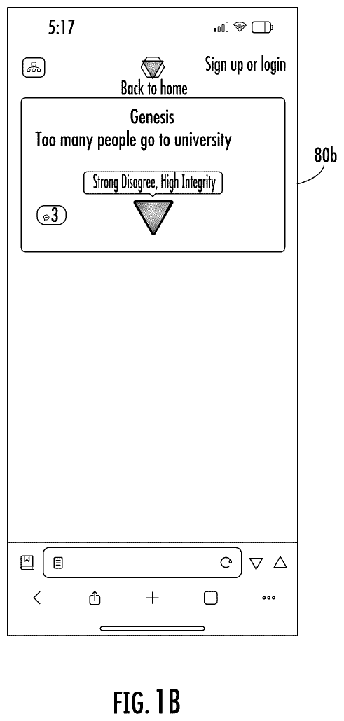

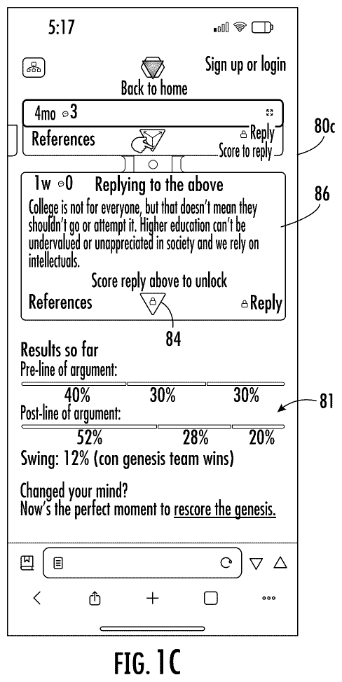

FIGS. 1A-1C show screenshots 80a, 80b and 80c from a client device of a user that sees an initial message 82 (or genesis statement) posted by a of a social media platform and a scoring triangle 84. The user can engage with the scoring triangle 84 to provide a score for the initial message 82. The screenshot 10 can also show the number of replies 86 to the initial message 82 currently has. A user is not granted access to the replies of the initial message 82 until after the user has used the scoring triangle 84 to score the initial message 82. The scoring triangle 84 offers the user the ability to score the initial message in multiple ways simultaneously. For example, the user can give an agreeance score (i.e., how much do they agree or disagree with the initial message 82) and an integrity score (i.e., how much weight do they give to the integrity of the comment of the person who posted the initial message 82). While an agreeance score and an integrity score are described herein, it should be understood and appreciated that the scoring triangle 84 could have any number of scoring metrics set assigned thereto.

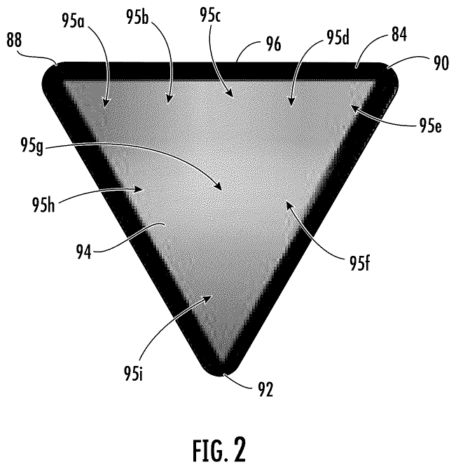

A close-up view of the scoring triangle 84 is shown in FIG. 2. The scoring triangle 84 can include a first upper corner 88, a second upper corner 90, a lower corner 92 and a gradient area 94 disposed within the corners 88, 90 and 92. Each corner of the scoring triangle 84 can be associated with the outer range of whatever metrics are used for the scoring triangle 84. In an exemplary embodiment, the first upper corner 88 can be associated with “strongly disagree” with the initial message 82 and the second upper corner 90 can be associated with “strongly agree” with the initial message 82. Therefore, the user can give a weighted agreeance score depending on where the user engages the gradient area 94 of the scoring triangle 84 horizontally between the first and second upper corners 88 and 90. Similarly, the upper part 96 of the scoring triangle 84 can correspond to the user scoring the person who made the initial message 82 with high integrity. Conversely, the lower corner 92 of the scoring triangle 84 would constitute a very low integrity score for the person who posted the initial message 82. Like the agreeance score, the user can give a weighted integrity score depending on where the user engages the gradient area 94 of the scoring triangle 84 vertically between the upper part 96 of the scoring triangle 84 and the lower corner 92 of the scoring triangle 84. Therefore, where a user engages the gradient area 94 of the scoring triangle 84 corresponds to a particular agreeance score and integrity score.

In another embodiment, the scoring triangle 84 can have 9 distinct score zones 95 for the message the scoring triangle 84 is being used to score. Each distinct score zone 95 can have an agreeance component and an integrity component. Each distinct score zone 95 has the following score:
a first score zone 95a—Strongly Disagree, High Integrity.
a second score zone 95b—Disagree, High Integrity.
a third score zone 95c—Neutral, High Integrity.
a fourth score zone 95d—Agree, High Integrity.
a fifth score zone 95e—Strongly Agree, High Integrity.
a sixth score zone 95f—Agree, Neutral Integrity.
a seventh score zone 95g—Neutral, Neutral Integrity.
an eighth score zone 95h—Disagree, Neutral Integrity.
a ninth score zone 95i—Neutral, Low Integrity
   It should be understood and appreciated that the number of score zones 95 for the scoring triangle 84 could be greater than 9. For example, there could be more than 5 score zones 95 across the top and more than three levels of score zones 95 vertically for the scoring triangle 84.

The gradient area 94 of the scoring triangle 84 can be a colored gradient such that the first upper corner 88 of the scoring triangle 84 is a first color, the second upper corner 90 of the scoring triangle 84 is a second color and the lower corner of the scoring triangle 84 is a third color. Depending on where the user engages the scoring triangle 84 to provide a score for the initial message 82, the score will correspond to a color from the gradient area 94. Shown in FIG. 1B, the initial message 82 can include a border 98 that will change color to match the color of the gradient area 94 as the user's cursor, mouse, finger is hovering over. Once a spot on the gradient area 94 is selected, the color of the border will officially be changed to match the color associated with the score given to the initial message 82.

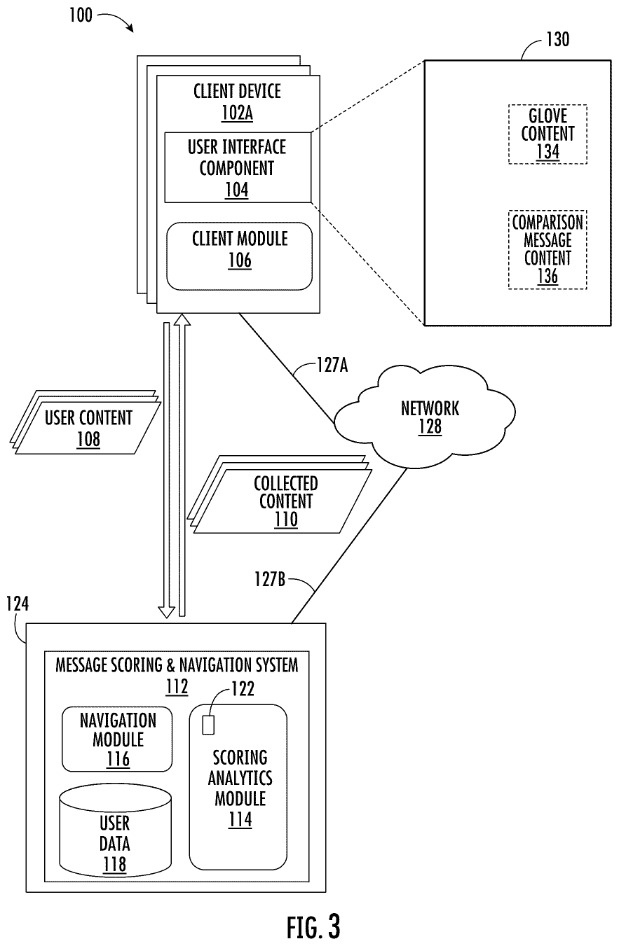

FIG. 3 is a conceptual diagram illustrating a system 100 for comparing scoring and analyzing of social media messages and navigating social media messages, in accordance with one or more aspects of the present disclosure. System 100 includes one or more client devices 102, a message scoring and navigating system 112, a social media platform 124, and a network 128.

Network 128 represents any communication network (e.g., public, private, commercial, governmental, or residential) that communicatively links two or more computing devices or systems for the transmission of information. For example, network 128 may be a wireless and/or wired network for transmitting data between two or more computing devices located at two or more different physical locations. In some examples, network 128 may represent or include the Internet. Client devices 102 (including, for example, client device 102A), message scoring and navigating system 112, and the social media platform 124 may send and receive data via network 128 using various suitable communication techniques. For instance, data may be transmitted between the devices using communication links 127A-127C, which may be wired and/or wireless. Network 128 may include any required hardware for communicatively linking client device 102A, message scoring and navigating system 112, and the social media platform 124. For example, a network 128 may include various switches, hubs, routers, and other network equipment that provides for the exchange of information between the devices.

Client devices 102 represent any type of personal computing device from which a person can view, listen to, feel, or otherwise obtain output based on information received via a network, such as network 128. For example, client device 102A may be a laptop computer, a mobile telephone, phones, a tablet computers, a set-top box, a desktop computer, a server, a mainframe, a wearable device (e.g., a watch, computerized glasses, and the like), a personal digital assistant (PDA), a gaming system, a media player, an e-book reader, a television platform, a digital media player, an automobile navigation and/or entertainment system, or any other type of mobile and/or non-mobile computing device that is configured to communicate (e.g., transmit and receive data) across a network and output information received via the network to a user.

Client devices 102 include a user interface component 104. User interface component 104 may include various technologies for receiving input from, and/or outputting information to, a user of client device 102. For example, user interface component 104 may include a microphone, a touch screen or other type of presence-sensitive screen, and other types of sensors and input devices for receiving input from a user. User interface component 104 may also include a display (e.g., liquid crystal (LCD), light emitting diode (LED), organic light-emitting diode (OLED), or any other type of display), a speaker, a haptic feedback device, or any other type of output device for outputting visible, audible, and/or haptic feedback type information to a user of client device 104. Although illustrated as a presence-sensitive display integrated with client device 102, in some examples, user interface component 104 may be a display device, such as a monitor integrated in a laptop computer, or a standalone monitor coupled to a desktop computing device, to name only a few examples.

User interface component 104 may provide a user interface from which a user may interact with a client device 102 (such as client device 102A) to cause client device 102 to perform one or more operations. For example, user interface component 104 may give a user access to a service, provided by message scoring and navigating system 112, for receiving content (e.g., social media, news, television, streaming audio, streaming video, or other types of content) distributed across network 128. As further described in this disclosure, message scoring and navigating system 112 may, for instance, provide content via network 128 to client device 102A. Client device 102A may process and output the content as one or more graphical images, sounds, and haptic-feedback sensations, at user interface component 104 of client device 102A.

Client devices 102 may also include a client module 106. Client module 106 may send information generated by a user to and receive information from an information network provided by message scoring and navigating system 112. For instance, a user may have a user account stored at message scoring and navigating system 112. The user account may include a unique identifier (e.g., a username) for the user, authentication credentials, and personal information (e.g., name, phone number, email address, home address, to name only a few examples). Client module 106 may authenticate with message scoring and navigating system 112 based on authentication credentials provided by the user to client device 102.

In some examples, client module 106 provides a graphical user interface (GUI) that enables a user to generate or otherwise compose user content 108 that client module 102 sends to message scoring and navigating system 112. Such user content may include text, images, video, and/or audio information. In some examples, a user may compose a message that includes various content. When a user generates user content 108, client module 106 may send user content 108 to message scoring and navigating system 112, which may process and/or distribute the user content as further described in this disclosure.

In some such examples, client module 106 enables the user to perform one or more functions associated with user content. For instance, client module 106 may enable a user to “share,” “re-share,” “read,” and “follow” content as well as “follow” and “mention” other users. In some examples, “sharing” a message or content may refer to composing an original message or original content that is subsequently distributed by message scoring and navigating system 112 to other users. In some examples, “re-sharing” a message or content may refer to an operation initiated by a user to re-post a message or content that was originally generated by another user. In some examples, “reading” a message or content may refer to an activity of a user to view the message or content. In some examples, “following” may refer to an operation initiated by a user to subscribe to messages and/or user content of another user. As such, a user that follows a particular user may receive updates of messages and/or user content generated by the particular user. In some examples, “mentioning” a particular user may refer to an operation initiated by a user to identify or otherwise associate the particular user with a message or user content.

Client module 106 may perform operations described herein using software, hardware, firmware, or a mixture of both hardware, software, and firmware residing in and executing by client device 102 or at one or more other remote computing devices. As such, client module 106 may be implemented as hardware, software, and/or a combination of hardware and software. Client device 102 may execute client module 106 as or within a virtual machine executing on underlying hardware. Furthermore, client module 106 may be implemented in various ways. For example, client module 106 may be implemented as a downloadable or pre-installed application or “app.” In another example, client module 106 may be implemented as part of an operating system of client device 102.

As shown in FIG. 3, system 100 includes the message scoring and navigating system 112. In one example approach, the message scoring and navigating system 112 implement techniques of this disclosure to analyze scoring results from a unique scoring system using the scoring triangle 84 and manage navigation of messages for the users of the system 100. In one such example approach, the message scoring and navigating system 112 is implemented as one or more computing devices, including but not limited to one or more desktop computers, laptop computers, mainframes, servers, cloud computing systems, and the like. Similarly, the social media platform 124 can be implemented as one or more computing devices, including but not limited to one or more desktop computers, laptop computers, mainframes, servers, cloud computing systems, and the like.

In one example approach, the message scoring and navigating system 112 includes data and one or more modules that, when executed, perform one or more operations. For example, purposes, the message scoring and navigating system 112 includes a scoring analytics module 114, a navigation module 116 and user data repository 118. The message scoring and navigating system 112 may, however, include more or fewer modules or data in other examples. The user data repository 118 could also be included as part of the social media platform 124.

In the example of FIG. 3, user data repository 118 includes user data such as, for example, data representing user accounts and demographic data about each user. In one example approach, a user account for a user of the message scoring and navigating system 112 may include is not limited to: a username, password, phone number, email address, and home address. In some examples, the user data may also include, current location of the user, devices authenticated with the user, interests of the user, history of content generated by the user, history of content read and/or followed by a user, hashtags and/or mention tags used by the user, other users followed by the user, other users following the user, private messages sent and/or received by the user, and/or search history of the user, to name only a few examples.

The scoring analytics module 114 of the message scoring and navigating system 112 may construct and maintain information generated by users and/or operators of the message scoring and navigating system 112. The scoring analytics module 114 may receive user content 108 from one or more client devices, and store and organize the user content in the information network. The user content may be stored and organized using any number of data stores and data structures, such as but not limited to graphs, lists, tables, a Relational Database Management System (RDBMS), Object Database Management System (ODBMS), and/or Online Analytical Processing (OLAP) system.

In some examples, the scoring analytics module 114 may receive message score data and the navigation module 116 can receive message content as part of the user content 108 from the client devices 102. Message score data can be content information related to the message scored, the scores messages were given, a color associated with the score given and information about the user who scored the message. The message content can be information associated with a message that the navigation module 116 can use to determine if a user's proposed comment/reply to an initial message 82 is essentially the same as a previous comment/reply to the initial message 82. In one example approach, client module 106 generates a graphical user interface 130 for display that includes information included in collected content 110, such as score content 134 and comparison message content 136.

The scoring analytics module 114 receives initial scores for initial messages 82 and records them for the users. The scoring analytics module 114 can also receive rescores of initial messages 82 for the users. Based on the scores given to the initial messages 82, the scoring analytics module 114 can manipulate the score content 134 shown on the client device 102A. For example, the color of the border 82 can be changed to correspond to the score. The scoring analytics module 114 can track how often a user changes their initial score of a message after they have reviewed the replies to the initial message 82. The scoring analytics module 114 can also send invitations to the user to rescore the initial message 82 based on how the user might score a particular reply to the initial message 82. For example, if a user scores initially scores an initial message 82 with a high disagreeance, but later scores a replay to the initial message 82 that is supportive of the initial message 82 with a higher agreeance score, the scoring analytics module 114 can send the invitation to the user to rescore the initial message 82 based on this discrepancy.

Metrics can be established that link particular users replies to how often the corresponding initial message 82 is rescored. The scoring analytics module 114 can generate a persuasive score for users that have a certain correlation between their replies to initial messages 82 that are rescored higher or lower. The persuasive score can also be influenced by when a user is given the opportunity to rescore the initial message 82 in light of the user's scoring of a particular reply to the initial message 82. For example, if a user initially scores the initial message 82 negatively, but then scores a reply to the initial message that is supportive of the initial message 82 positively and the scoring analytics module 114 sends the user a chance to rescore the initial message 82 and the user rescores the initial message positively, this would increase the persuasive score of the user who posted the reply. FIG. 1C shows a screenshot 80c that displays metrics data 81 related to the scoring of initial messages 82 and scoring metrics for replies to the initial message 82.

The navigation module 116 controls a user's ability to maneuver around the social media platform 124. The navigation module 116 can receive information related to message scoring to permit a user to see replies to initial messages. The navigation module 116 can receive and analyze potential or prospective replies of users for an initial message. The navigation module 116 can send information to the user associated with another user's previous reply to the initial message that is essentially the same as the user's proposed/potential reply. This gives the user an opportunity to decide whether to post their response that the navigation module 116 determines is essentially a duplicate, score the other user's response or both. The navigation module 116 can artificial intelligence speech engine 122 (AISE) to analyze posted responses/replies of other users and proposed responses of the user to determine similarity of the replies. A certain similarity threshold can be used for when the navigation module 116 ultimately labels a proposed response from the user as similar enough to the other user's response to merit sending options to the user to go ahead and post their response, score the other user's previous reply or both.

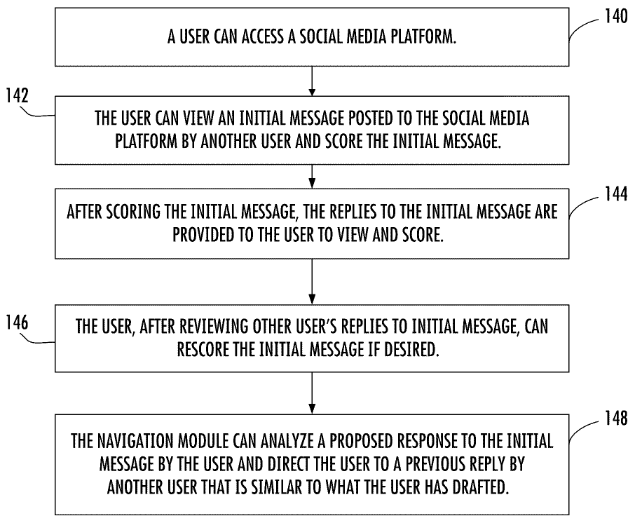

Referring now to FIG. 4, shown therein is a portion of the process contemplated by the system 100. To start at step 140, a social media user can access the social media platform on an application (app) downloaded to the client device 102A or through a website accessed via a browser on the client device 102A. The social media user can view initial messages via their client device 102A and score them using the scoring triangle 84 at step 142. At step 144, after scoring the initial message the replies to the initial message made by other users become available to user to view and score, via the navigation module 116. The social media user, at step 146, can have the option of rescoring the initial message after reviewing other user's replies to the initial message. At step 148, the navigation module 116 can evaluate a response/reply comment to the initial message 82 a user drafts and intends to post. The navigation module 116 can then provide to the user, via the client device 102A, a previous reply another user made to the initial message 82 the navigation module 116 determines is similar to the one the user has drafted.

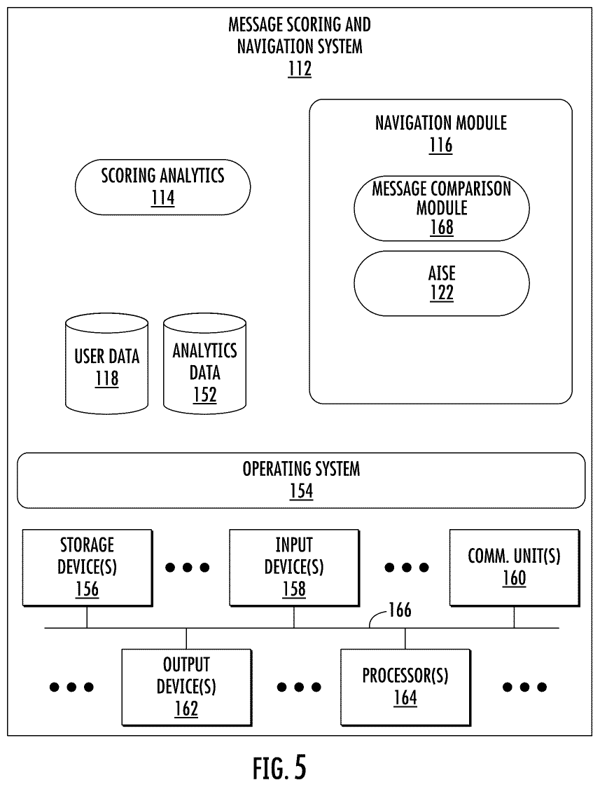

FIG. 5 is a block diagram illustrating further details of an example message scoring and navigation system for scoring social media messages and controlling certain aspects of a user's navigation of the social media platform, in accordance with one or more aspects of the present disclosure. The message scoring and navigation system 112 of FIG. 5 is described below within the context of FIG. 3. FIG. 5 illustrates only one particular example of the message scoring and navigation system 112, and many other examples of the message scoring and navigation system 112 may be used in other instances and may include a subset of the components included in example the message scoring and navigation system 112 or may include additional components not shown in FIG. 3.

As shown in the example of FIG. 5, the message scoring and navigation system 112 includes the scoring analytics module 114, the navigation module 116, user data 118, analytics data 152, an operating system 154, one or more storage devices 156, one or more input devices 158, one or more communication units 160, one or more output devices 162, one or more processors 164, and one or more communication channels 166. The navigation module 116 includes a message comparison module 168 and the AISE 122.

Communication channels 166 may interconnect each of the components 156-164 for inter-component communications (physically, communicatively, and/or operatively). In some examples, communication channels 166 may include a system bus, a network connection, an inter-process communication data structure, or any other method for communicating data.

One or more input devices 158 of the message scoring and navigation system 112 may receive input and one or more input devices 158 may generate output. Examples of input are tactile, audio, and video input and examples of output are tactile, audio, and video output. In one example, input devices 158 include a presence-sensitive display, touch-sensitive screen, mouse, keyboard, voice responsive system, video camera, microphone, or any other type of device for detecting input from a human or machine. Whereas in one example, output devices 162 include a presence-sensitive display, sound card, video graphics adapter card, speaker, cathode ray tube (CRT) monitor, liquid crystal display (LCD), or any other type of device for generating output to a human or machine.

One or more communication units 160 may allow the message scoring and navigation system 112 to communicate, via one or more wired and/or wireless networks, with external devices and/or systems. For example, communication units 160 may transmit and/or receive network signals being transmitted and received from other devices and/or systems connected to network 128. Examples of communication units 160 include network interface cards (e.g., such as an Ethernet card), optical transceivers, radio frequency transceivers, GPS receivers, or any other type of device that can send and/or receive information via a network. Other examples of communication units 160 may include long and short wave radios, cellular data radios, wireless network radios, as well as universal serial bus (USB) controllers.

One or more storage devices 156 of the message scoring and navigation system 112 may store information or instructions that the message scoring and navigation system 112 processes during operation of the message scoring and navigation system 112. For example, storage devices 156 may store data that modules or components may access during execution at the message scoring and navigation system 112. In some examples, storage devices 156 are temporary memories, meaning that a primary purpose of storage devices 156 is not long-term storage.

Storage devices 156 may be configured for short-term storage of information as volatile memory and therefore not retain stored contents if powered off. Examples of volatile memories include random access memories (RAM), dynamic random access memories (DRAM), static random access memories (SRAM), and other forms of volatile memories known in the art.

Storage devices 156 may be configured to store larger amounts of information than volatile memory and may further be configured for long-term storage of information as non-volatile memory space and retain information after power on/off cycles. Examples of non-volatile memories include magnetic hard discs, optical discs, floppy discs, flash memories, or forms of electrically programmable memories (EPROM) or electrically erasable and programmable (EEPROM) memories.

Storage devices 156, in some examples, include one or more computer-readable storage media. In some examples, storage devices 156 represent non-transitory computer readable storage medium that store instructions later executed by one or more processors 164 during operation of the message scoring and navigation system 112. For example, storage devices 156 may store program instructions and/or information (e.g., data) associated with modules and/or components described herein.

One or more processors 164 may implement functionality and/or execute instructions within the message scoring and navigation system 112. For example, processors 164 on the message scoring and navigation system 112 may receive and execute instructions stored by storage devices 156 that execute the functionality of the modules described herein. The instructions executed by processors 164 may cause the message scoring and navigation system 112 to read/write/etc. information, such as one or more data files at user data 118 and/or analytics data 152 and stored within storage devices 156 during program execution. Processors 164 may execute instructions of the described herein to cause the message scoring and navigation system 112 to perform the operations described in this disclosure. That is, the modules described herein may be operable by processors 164 to perform various actions or functions of the message scoring and navigation system 112, for instance, detecting scoring changes to initial messages 82 after replies 86 are provided to the user, in accordance with one or more aspects of the present disclosure.

As shown in FIG. 5 the message scoring and navigation system 112 also includes scoring analytics module 114 and navigation module 116 as previously described in FIG. 3. The navigation module 116 may also include one or more of message comparison module 168 and the AISE 122, each of which are described in further detail in FIG. 3.

From the above description, it is clear that the present disclosure is well-adapted to carry out the objectives and to attain the advantages mentioned herein as well as those inherent in the disclosure. While presently preferred embodiments have been described herein, it will be understood that numerous changes may be made which will readily suggest themselves to those skilled in the art and which are accomplished within the spirit of the disclosure and claims.

What is claimed is:

1. A method for scoring messages on a social media platform, analyzing the scores and controlling navigation of the social media platform, the method comprising:
providing, by a computing device, a scoring triangle to a client device of a user of a social media platform associated with an initial message posted to the social media platform.

2. The method of claim 1 further comprising the step of receiving a score at the computing device from the client device of the user by manipulating the scoring triangle and providing replies to the initial message to the client device of the user.

3. The method of claim 2 further comprising the step of receiving, at the computing device, scores to the replies to the initial message sent from the user via the client device.

4. The method of claim 3 further comprising the step of receiving, at the computing device, a proposed reply to the initial message from the user and analyzing the proposed reply, via the computing device, to determine if there is already a reply to the initial message from another user of the social media platform that is similar to the proposed reply.

5. The method of claim 4 further comprising the step of sending, via the computing device, to the client device of the user the similar message to the proposed reply to provide the user an option to score the similar message and elect not to post their proposed reply.

6. The method of claim 5 further comprising the step of receiving a score, at the computing device, from the user for a reply to the initial message that is similar to the initial message and comparing the score for the reply and the score for the initial message.

7. The method of claim 6 further comprising the step of sending, via the computing device, to the user an option to rescore the initial message based on the score the user gave for the reply to the initial message that was similar to the initial message.

8. The method of claim 7 further comprising the step of generating, via the computing device, a persuasive score for a user responsive to when other users of the social media platform rescore the initial message after scoring the user's reply.

9. The method of claim 1 wherein the scoring triangle allows users to score a message two ways simultaneously depending on where on the scoring triangle the user selects.

10. The method of claim 9 wherein the scoring triangle includes an agreeance metric along one side thereof and an integrity metric across a depth of the scoring triangle.

11. A computing device for scoring messages on a social media platform, analyzing the scores and controlling navigation of the social media platform, the computing device comprising:
at least one processor;
at least one computer-readable medium storing instructions that are executable by the at least one processor to:
display a scoring triangle on a client device of a user of a social media platform associated with an initial message posted to the social media platform.

12. The computing device of claim 11 wherein the instructions further include instructions that are executable by the at least one processor to receive a score from the user of the client device by manipulating the scoring triangle and to provide replies to the initial message to the client device of the user.

13. The computing device of claim 12 wherein the instructions further include instructions that are executable by the at least one processor to receive scores to the replies to the initial message sent from the user via the client device.

14. The computing device of claim 13 wherein the instructions further include instructions that are executable by the at least one processor to receive a proposed reply to the initial message from the user and to analyze the proposed reply to determine if there is already a reply to the initial message from another user of the social media platform that is similar to the proposed reply.

15. The computing device of claim 14 wherein the instructions further include instructions that are executable by the at least one processor to send to the client device of the user the similar message to the proposed reply to provide the user an option to score the similar message and elect not to post their proposed reply.

16. The computing device of claim 15 wherein the instructions further include instructions that are executable by the at least one processor to receive a score from the user for a reply to the initial message that is similar to the initial message and to compare the score for the reply and the score for the initial message.

17. The computing device of claim 16 wherein the instructions further include instructions that are executable by the at least one processor to send to the user an option to rescore the initial message based on the score the user gave for the reply to the initial message that was similar to the initial message.

18. The computing device of claim 17 wherein the instructions further include instructions that are executable by the at least one processor to generate a persuasive score for a user responsive to when other users of the social media platform rescore the initial message after scoring the user's reply.

19. The computing device of claim 11 wherein the scoring triangle allows users to score a message two ways simultaneously depending on where on the scoring triangle the user selects.

20. The computing device of claim 19 wherein the scoring triangle includes an agreeance metric along one side thereof and an integrity metric across a depth of the scoring triangle.
